(19) United States
(12) Patent Application Publication
(10) Pub. No.: US 2004/0110503 A1
(43) Pub. Date: Jun. 10, 2004

(54) Method and mobile communication system for providing an improved roaming service

(75) Inventor: Hong-Ju Park, Songnam-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/694,612

(22) Filed: Oct. 27, 2003

(30) Foreign Application Priority Data
Oct. 26, 2002 (KR) 2002/65679

(51) Int. Cl. H04Q 7/20; H04M 1/00; H04B 1/38

(52) U.S. Cl. 455/435.1; 455/437; 455/456.1; 455/560

(57) ABSTRACT

An improved roaming method of a mobile communication system. At the time of location registration or system information transmission, a sub-PLMN (Public Land Mobile Network) in which an MS (Mobile Station) is located provides a valid roaming list that is configured by system ID information of peripheral sub-PLMNs whose roaming services can be provided, and the MS compares the received valid roaming list with a previously stored roaming list and determines whether it should perform a scan procedure for roaming, thereby removing an unnecessary operation of the MS and saving power of the MS.

This application claims priority to an application entitled “METHOD AND MOBILE COMMUNICATION SYSTEM FOR PROVIDING IMPROVED ROAMING SERVICE”, filed in the Korean Industrial Property Office on Oct. 26, 2002 and assigned Serial No. 2002-65679, the contents of which are hereby incorporated by reference.

### BACKGROUND OF THE INVENTION

1. Field of the Invention

The present invention relates generally to a mobile communication system, and more particularly to a method and mobile communication system for providing an improved roaming service.

2. Description of the Related Art

A cellular mobile communication system divides an entire service area into service areas or cells of a plurality of BTSs (Base Transceiver Stations) and performs centralized control for the BTSs through an MSC (Mobile Switching Center), thereby enabling a subscriber to continuously carry out communication while moving between cells. FIG. 1 illustrates a conventional cellular mobile communication system. Referring to FIG. 1, BTSs 130, 140, and 230 transmit particular pilot signals and carry out communications by connecting MSs (Mobile Stations) 150 and 160 and a radio channel, in cells.

When an MS moves between BTSs belonging to different PLMNs (Public Land Mobile Networks) classified by an MSC or a service carrier, or is placed in an overlap service area of the BTSs belonging to the different PLMNs, or belongs to a VPLMN (Visitor PLMN), a roaming service is provided to the MS according to a convention between systems. For example, referring to FIG. 1, when the MS is moved from a service area of a BTSa1 130 belonging to a PLMN A 100 to a service area of a BTSb1 230 belonging to a PLMN B 200, or is placed in an overlap service area (OA), a roaming service is provided by a convention between the PLMN A 100 and the PLMN B 200.

In a preferred roaming service for MSs, the MS determines whether a new BTS supports the roaming service. To determine whether the new BTS supports the roaming service, the MS stores IDs (Identifications) of PLMN systems and a preferred roaming list containing roaming priorities of PLMNs. Further, the MS identifies system IDs of peripheral PLMNs located within serviceable distances through a synchronous channel, and performs a scan procedure for comparing the identified system IDs with the roaming list. If a system ID provided from a peripheral BTS exists in the roaming list and a peripheral PLMN is of higher-order roaming priority than a PLMN currently providing service, the MS is registered in the peripheral PLMN so that the MS can perform a roaming procedure for the peripheral PLMN. Alternatively, if a peripheral PLMN does not exist in the roaming list or a peripheral PLMN is not of higher-order roaming priority than the PLMN currently providing service, a roaming procedure is not performed for a new PLMN.

The scan procedure for performing the roaming procedure described above is periodically performed. However, when there is no peripheral PLMN, that is, when the MS is placed within an HPLMN (Home PLMN) or there is no system of higher-order priority than a system currently providing service and located within a serviceable distance, there are problems in that the scan procedure is unnecessarily performed in the MS, and hence power is unnecessarily consumed during the scan procedure.

### SUMMARY OF THE INVENTION

Therefore, the present invention has been designed in view of the above problems, and it is an object of the present invention to provide a method and mobile communication system for providing a roaming service capable of eliminating an unnecessary scan procedure.

It is another object of the present invention to provide a method and mobile communication system for providing a roaming service capable of saving power of an MS (Mobile Station).

In accordance with one aspect of the present invention, the above and other objects can be accomplished by a cellular mobile communication system comprising a plurality of sub-mobile communication systems for configuring a plurality of sub-PLMNs (Public Land Mobile Networks) that are classified by an MSC (Mobile Switching Center) or a service carrier, each sub-mobile communication system including: an MSC for storing system ID information of peripheral sub-PLMNs whose roaming services can be provided according to a geometric location and a convention, identifying a current location of an MS (Mobile Station), configuring a valid roaming list including system IDs of peripheral sub-PLMNs whose roaming services can be provided according to the current location of the MS, and transmitting the valid roaming list; and a plurality of MSs for storing a roaming list including system IDs of sub-PLMNs whose roaming services can be provided according to the convention, comparing the received valid roaming list and the stored roaming list, scanning a peripheral sub-PLMN after a predetermined period of time if a sub-PLMN having a higher-order priority than a sub-PLMN currently providing a radio service exists in at least one sub-PLMN contained in the valid roaming list, and performing a roaming procedure for the sub-PLMN of the higher-order priority.

In accordance with another aspect of the present invention, there is provided a method for providing a roaming service in a cellular mobile communication system including a plurality of sub-mobile communication systems for configuring a plurality of sub-PLMNs (Public Land Mobile Networks) that are classified by an MSC (Mobile Switching Center) or a service carrier, comprising the steps of: a) storing system ID information of peripheral sub-PLMNs whose roaming services can be provided according to a geometric location and a convention, in an MSC; b) identifying a current location of an MS (Mobile Station), configuring a valid roaming list including system IDs of peripheral sub-PLMNs whose roaming services can be provided according to the current location of the MS, and transmit the valid roaming list, in the MSC; c) comparing the received valid roaming list with a roaming list including system IDs of sub-PLMNs whose roaming services can be provided and roaming priorities, in the MS; and d) scanning a peripheral sub-PLMN after a predetermined period of time if a sub-PLMN having a higher-order priority than a sub-PLMN currently providing a radio service exists in at least one sub-PLMN contained in the valid roaming list as a result of the comparison, and perform a roaming procedure for the sub-PLMN of the higher-order priority, in the MS.

### BRIEF DESCRIPTION OF THE DRAWINGS

The above and other objects, features, and advantages of the present invention will be more clearly understood from the following detailed description taken in conjunction with the accompanying drawings, in which:

FIG. 1 illustrates a cellular mobile communication system to which the present invention is applied;

FIG. 2 illustrates an MS (Mobile Station) in accordance with an embodiment of the present invention;

FIG. 3 illustrates a message flow in accordance with an embodiment of the present invention; and

FIG. 4 is a flow chart illustrating an operation of the MS in accordance with an embodiment of the present invention.

### DETAILED DESCRIPTION OF THE PREFERRED EMBODIMENTS

Preferred embodiments of the present invention will be described in detail herein below with reference to the annexed drawings. Further, in the following description of the present invention, a detailed description of known functions and configurations incorporated herein will be omitted when it may make the subject matter of the present invention rather unclear.

The present invention is applied to a cellular mobile communication system, which configures a PLMN (Public Land Mobile Network). The PLMN is made up of a plurality of sub-PLMNs classified by an MSC (Mobile Switching Center) or a service carrier, and a sub-PLMN is configured by a sub-mobile communication system.

In the cellular mobile communication system, a sub-PLMN to which an MS (Mobile Station) belongs provides a valid roaming list containing system ID information of sub-PLMNs whose roaming services can be provided, and the MS compares a previously stored roaming list with the received valid roaming list to determine whether a scan procedure should be performed, thereby eliminating an unnecessary operation and saving power of the MS.

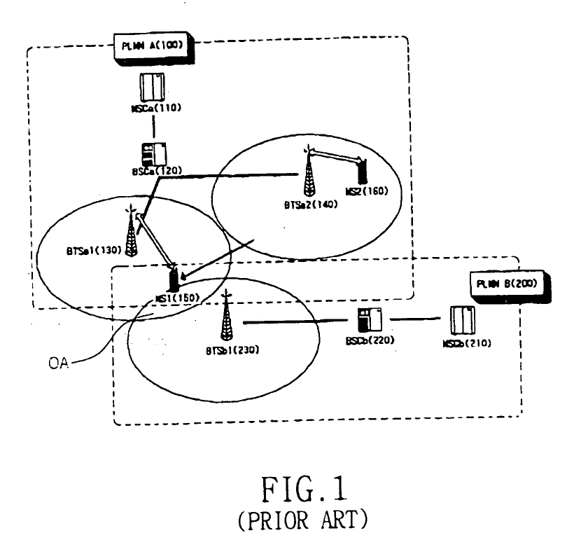

FIG. 1 illustrates a cellular mobile communication system to which the present invention applied. As illustrated in FIG. 1, the cellular mobile communication system is made up of a plurality of sub-PLMNs, i.e., sub-PLMNs 100 and 200, classified by an MSC or a service carrier. The sub-PLMNs 100 and 200 are configured by MSCs 110 and 210, a plurality of BSCs (Base Station Controllers) 120 and 220, a plurality of BTSs (Base Transceiver Stations) 130, 140, and 230, and a plurality of MSs 150 and 160.

In the cellular mobile communication system, a sub-PLMN A 100 and a sub-PLMN B 200 are sub-PLMNs, which are controlled by different carriers in accordance with the embodiment of the present invention, and provide radio services in a specific overlap area OA. An MSCa 110 and an MSCb 210 of the sub-PLMNs 100 and 200 provide roaming services based on a convention. Further, the sub-PLMN A 100 and the sub-PLMN B 200 correspond to VPLMNs (Visitor PLMNs) associated with the MSs 150 and 160. In this example, the sub-PLMN A 100 is of higher-order roaming priority than the sub-PLMN B 200.

The MSCs 110 and 210, which are connected to a plurality of BSCs, are wired/wireless composite digital switches for providing a wired communication function (associated with PSTN (Public Switched Telephone Network)/ISDN (Integrated Services Digital Network)) and a mobile communication function, processing basic and supplementary services, processing incoming and outgoing calls associated with an MS by interworking with an existing network and other network, and processing location registration and handoff. In accordance with the present invention, the MSCs 110 and 210 store system ID information of peripheral sub-PLMNs whose roaming services can be provided, according to geometric locations and convention conditions of the MSCs 110 and 210, and configure a valid roaming list containing system IDs of peripheral sub-PLMNs whose roaming services can be provided, according to a current location of an MS requesting location registration. In accordance with the embodiment of the present invention, each of the MSCs 110 and 210 receives a location registration update request message from an MS, and transmits a location registration update permission message containing the valid roaming list to the MS.

The BSCs 120 and 220, which are, arranged between MSCs and BTSs, manage and control a plurality of BTSs. The BSCs 120 and 220 assign and release a radio channel of each MS, control transmission power of MSs and BTSs, and decide soft handoff and hard handoff between cells. Further, the BSCs 120 and 220 perform a transcoding function and a vocoding function, distribute GPS (Global Positioning System) clocks for handoff and signal processing, and manage and maintain the BTSs. Furthermore, in accordance with the present invention, the BSCs 120 and 220 transmit valid roaming lists to connected BTSs under control of the MSCs 110 and 210. The BSCa 120 is connected to the MSCa 110, and the BSCb 220 is connected to the MSCb 220.

The BTSs 130, 140, and 230 are network termination devices connected to BSCs, and perform baseband signal processing, wired and wireless conversion and transmission and reception of radio signals with MSs under control of BSCs. Moreover, the BTSs 130, 140, and 230 transmit valid roaming lists received from the connected BSCs to MSs. The BTSa1 130 and the BTSa2 140 are connected to the BSCa 120, and the BTSb1 230 is connected to the BSCb 220.

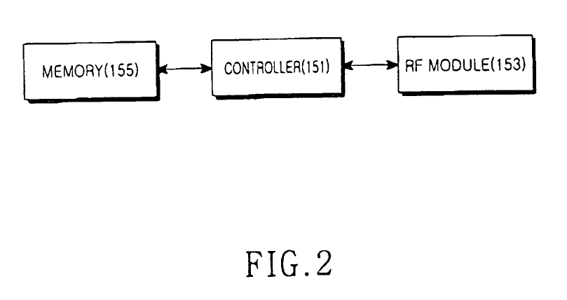

As illustrated in FIG. 2, each of the MSs 150 and 160 includes a controller 151, an RF (Radio Frequency) module 153, and a memory 155. FIG. 2 illustrates an MS (Mobile Station) in accordance with an embodiment of the present invention. The controller 151 performs an entire control operation of an MS. The RF module 153 transmits and receives voice data and control data under control of the controller 151. The memory 155 stores program data needed at the time of controlling an MS operation and data generated at the time of control or while the MS is operated by a user. Further, the memory 155 stores a roaming list containing system IDs of sub-PLMNs, which can provide roaming services based on, a convention, and roaming priority information of the sub-PLMNs. The controller 151 analyzes valid roaming lists received from the MSCs 110 and 210 through the BTSs 130, 140, and 230 in accordance with the embodiment of the present invention, and compares a valid roaming list with a previously stored roaming list. If a system ID of a sub-PLMN having higher-order roaming priority than a sub-PLMN to which an MS belongs exists in the valid roaming list as a result of the comparison, the controller 151 performs a scan procedure relating to a peripheral sub-PLMN to perform a roaming procedure.

Further, in accordance with the embodiment of the present invention, the MS1 150 is an MS, which enters a service area of the BTSa1 130 from a service area of the BTSa2 140. In accordance with another embodiment of the present invention, the MS2 160 is an MS, which is in a power-on state in the service area of the BTSa2 140.

In the mobile communication system as described above, if the MS 150 or 160 is located in a service area of a BTS, placed in a power-on state, or needs a location registration update, the MS 150 or 160 transmits a location registration request message to the BTS corresponding to the service area in which it is currently located. The BTS receives the location registration request message and then transmits it to an MSC through a connected BSC. If the MSC receives the location registration request, it performs location registration of a corresponding MS and then transmits a location registration permission message and a valid roaming list contained therein to the MS.

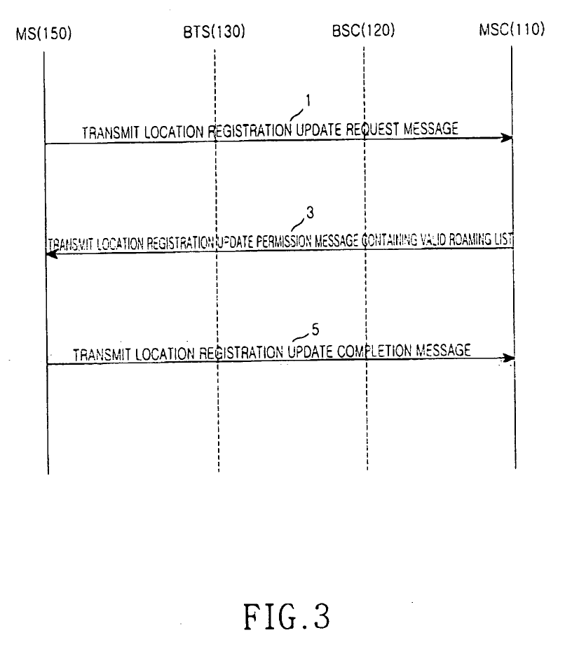

The above-described procedure will be described with reference to FIGS. 1 and 3 herein below. FIG. 3 illustrates a message flow in accordance with an embodiment of the present invention. As an example, a case where an MS enters a new service area in a power-on state, e.g., the MS1 150 illustrated in FIG. 1, will be described with reference to FIGS. 1 and 3.

As illustrated in FIG. 1, if the MS1 150 enters a new service area of the BTSa1 130, it transmits a location registration update request message to the BTSa1 130 at step 1 of FIG. 3. The location registration update request message is transmitted to the MSCa 110 through the BTSa1 130 and the BSCa 120. If the MSCa 110 receives the location registration update request message, it updates location registration information of the MS1 150. Further, the MSCa 110 configures a valid roaming list containing system ID information of sub-PLMNs whose roaming services can be provided in the MS1's current location, from previously stored system ID information of peripheral sub-PLMNs. At step 3, the MSCa 110 incorporates the configured valid roaming list in a location registration update permission message, and then transmits the location registration update permission message to the MS1 150 through the BSCa 120 and the BTSa1 130. At this time, because the MS1 150 is located in an overlap service area of the sub-PLMN A 100 and the sub-PLMN B 200, the valid roaming list includes a system ID of the sub-PLMN B 200.

The procedure in steps 1 and 3 is performed for the MS2 160 illustrated in FIG. 1. The MS2 160 is an MS in a power-on state in a radio service area of the BTSa2 140 in accordance with another embodiment of the present invention. The MS2 160 in the power-on state transmits a location registration update request message to the BTSa2 140. The BTSa2 140 transmits the location registration update request message to the MSCa 110 through the BSCa 120. The MSCa 110 updates location registration information of the MS2 160. Further, the MSCa 110 creates a valid roaming list based on a current location of the MS2 160, and incorporates the created valid roaming list in a location registration update permission message to transmit the list to the MS2 160. At this time, because an area in which the MS2 160 is located is not a radio service area of the sub-PLMN B 200, the valid roaming list received by the MS2 160 does not include a system ID of the sub-PLMN B 200. Valid roaming lists are differently configured according to locations of an MS.

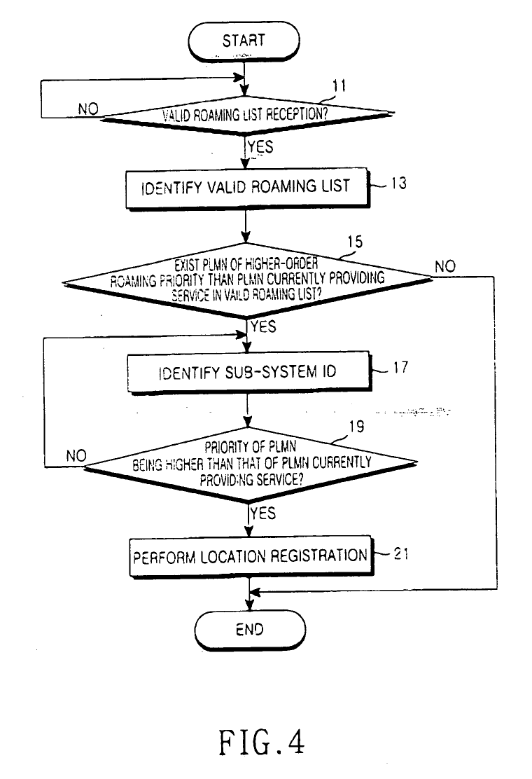

Again referring to FIG. 3, if the MS1 150 receives the location registration update permission message, it transmits the location registration update completion message at step 5, and then performs an operation based on a procedure illustrated in FIG. 4. That is, the MS 150 or 160 receiving the location registration update permission message extracts the valid roaming list from the location registration update permission message and then compares the extracted valid roaming list with a previously stored roaming list. If a system ID of a sub-PLMN having higher-order priority than a sub-PLMN currently providing a radio service to the MS 150 or 160 exists in the valid roaming list as a result of the comparison, the MS 150 or 160 performs a scan procedure for roaming after a predetermined period of time. The procedure will be described in more detail herein below with reference to FIG. 4.

FIG. 4 is a flow chart illustrating an operation of the MS in accordance with an embodiment of the present invention. A procedure where the MS 150 or 160 receives a valid roaming list and then performs a roaming process using the received valid roaming list, is illustrated in FIG. 4. Referring to FIG. 4, the MS 150 or 160 determines whether a valid roaming list has been received from a BTS at step 11, and proceeds to step 13 if the valid roaming list has been received. The MS 150 or 160 identifies the valid roaming list in step 13. The MS 150 or 160 determines, in step 15, whether a system ID of a sub-PLMN having a higher-order priority than a sub-PLMN currently providing a radio service exists in the valid roaming list. If a system ID of a sub-PLMN having higher-order priority than a sub-PLMN currently providing a radio service exists in the valid roaming list as a result of the determination, the MS 150 or 160 proceeds to step 17. Otherwise, the procedure is terminated. The roaming priority is highest in an HPLMN (Home PLMN), and other priorities are decided by a convention between mobile communication carriers or sub-PLMNs, and signal intensity between BTSs, and are stored in an MS. The MS 150 or 160 obtains a system ID when the MS 150 or 160 is in synchronization with a signal of some sub-PLMN after a predetermined period of time at step 17, compares roaming priorities of some sub-PLNM and a sub-PLMN currently providing a radio service, and proceeds to step 19. If priority of some sub-PLMN is higher than that of the sub-PLMN currently providing a radio service at the above step 19, the MS 150 or 160 proceeds to step 21. If priority of any sub-PLMN is not higher than that of the sub-PLMN currently providing a radio service, the MS 150 or 160 returns to step 17 and then repeats the above steps 17 to 19 until some sub-PLMN having a higher-order priority is scanned. On the other hand, at step 21, the MS 150 or 160 performs location registration to the sub-PLMN of the higher-order priority, and performs the roaming procedure until it is completed.

In accordance with the present invention, the MS 150 or 160 performs a series of operations for a roaming procedure if a system ID of a PLMN having a higher-order priority than a PLMN to which the MS 150 or 160 belongs exists in a received valid roaming list. However, if the system ID does not exist, the operation for a roaming procedure is not performed. Thus, in the present invention, it is possible to omit an unnecessary PLMN scanning operation and to reduce battery consumption in a mobile station.

As is apparent from the above description, the present invention provides an improved roaming method of a mobile communication system. At the time of location registration or system information transmission, a sub-PLMN in which an MS is located provides a valid roaming list configured by system ID information of peripheral sub-PLMNs whose roaming services can be provided, and the MS compares the received valid roaming list with a previously stored roaming list and determines whether it should perform a scan procedure for roaming, thereby removing an unnecessary operation of the MS and saving power of the MS.

Although the preferred embodiments of the present invention have been disclosed for illustrative purposes, those skilled in the art will appreciate that various modifications, additions and substitutions can be provided, without departing from the scope of the invention. For example, an embodiment for the case where the location registration update permission message containing the valid roaming list is transmitted to the MS has been described, but the valid roaming list can be transmitted to the MS of each BTS at the time of system information transmission. In other words, each BTS stores a valid roaming list configured by system ID information of sub-PLMNs whose roaming services can be provided on the basis of geometric locations and transmits the valid roaming list to the MS at the time of system information transmission. In addition, the MSC can transmit the valid loaming list to the mobile station through a BCCH (Broadcasting channel) without requesting a separate valid loaming list. Accordingly, the present invention is not limited to the above-described embodiments, but the present invention is defined by the claims that follow, along with their full scope of equivalents.

What is claimed is:

1. A cellular mobile communication system comprising a plurality of sub-mobile communication systems for configuring a plurality of sub-PLMNs (Public Land Mobile Networks) that are classified by an MSC (Mobile Switching Center), each sub-mobile communication system including:
an MSC for storing system ID information of peripheral sub-PLMNs whose roaming services can be provided according to a geometric location and a convention, identifying a current location of an MS (Mobile Station), configuring a valid roaming list including system IDs of peripheral sub-PLMNs whose roaming services can be provided according to the current location of the MS, and transmitting the valid roaming list; and
a plurality of MSs for storing a roaming list including system IDs of sub-PLMNs whose roaming services can be provided according to the convention, comparing the received valid roaming list and the stored roaming list, scanning a peripheral sub-PLMN after a predetermined period of time if a sub-PLMN having a higher-order priority than a sub-PLMN currently providing a radio service exists in at least one sub-PLMN contained in the valid roaming list, and performing a roaming procedure for the sub-PLMN of the higher-order priority.

2. The cellular mobile communication system as set forth in claim 1, wherein the MSC transmits the valid roaming list at a location registration of the MS.

3. The cellular mobile communication system as set forth in claim 1, wherein the MSC transmits the valid loaming list to the mobile station through a BCCH (Broadcasting channel.

4. A cellular mobile communication system comprising a plurality of sub-mobile communication systems for configuring a plurality of sub-PLMNs (Public Land Mobile Networks) that are classified by an MSC (Mobile Switching Center), each sub-mobile communication system including:
a plurality of BTSs (Base Transceiver Stations) for storing system ID information of peripheral sub-PLMNs whose roaming services can be provided according to a geometric location and a convention, and transmitting a valid roaming list at the time of system information transmission; and
a plurality of MSs (Mobile Stations) for storing a roaming list including system IDs of sub-PLMNs whose roaming services can be provided according to the convention, comparing the received valid roaming list and the stored roaming list, scanning a peripheral sub-PLMN after a predetermined period of time if a sub-PLMN having a higher-order priority than a sub-PLMN currently providing a radio service exists in at least one sub-PLMN contained in the valid roaming list, and performing a roaming procedure for the sub-PLMN of the higher-order priority.

5. A method for providing a roaming service in a cellular mobile communication system including a plurality of sub-mobile communication systems for configuring a plurality of sub-PLMNs (Public Land Mobile Networks) that are classified by an MSC (Mobile Switching Center), comprising the steps of:
a) storing system ID information of peripheral sub-PLMNs whose roaming services can be provided according to a geometric location and a convention, in an MSC;
b) identifying a current location of an MS (Mobile Station), configuring a valid roaming list including system IDs of peripheral sub-PLMNs whose roaming services can be provided according to a current location of the MS, and transmitting the valid roaming list, in the MSC;
c) comparing the received valid roaming list with a roaming list including system IDs of sub-PLMNs whose roaming services can be provided and roaming priorities, in the MS; and
d) scanning a peripheral sub-PLMN after a predetermined period of time if a sub-PLMN a having higher-order priority than a sub-PLMN currently providing a radio service exists in at least one sub-PLMN contained in the valid roaming list as a result of the comparison, and perform a roaming procedure for the sub-PLMN of the higher-order priority, in the MS.

6. The method as set forth in claim 5, wherein the MSC transmits the valid roaming list when the MS requests a location registration update.

7. A method for providing a roaming service in a cellular mobile communication system including a plurality of sub-mobile communication systems for configuring a plurality of sub-PLMNs (Public Land Mobile Networks) that are classified by an MSC (Mobile Switching Center), comprising the steps of:
a) storing system ID information of peripheral sub-PLMNs whose roaming services can be provided according to a geometric location and a convention, in an MSC;
b) transmitting a location registration update request to the MSC, from an MS (Mobile Station);
c) if the MSC receives the location registration update request, configuring a valid roaming list including system IDs of peripheral sub-PLMNs whose roaming services can be provided according to a current location of the MS, and transmitting the valid roaming list;
d) comparing the received valid roaming list with a roaming list made up of system IDs of sub-PLMNs whose roaming services can be provided and roaming priorities, in the MS; and
e) scanning a peripheral sub-PLMN after a predetermined period of time if a sub-PLMN having a higher-order priority than a sub-PLMN currently providing a radio service exists in at least one sub-PLMN contained in the valid roaming list as a result of the comparison, and perform a roaming procedure for the sub-PLMN of the higher-order priority, in the MS.

8. A method for providing a roaming service in a cellular mobile communication system including a plurality of sub-mobile communication systems for configuring a plurality of sub-PLMNs (Public Land Mobile Networks) that are classified by an MSC (Mobile Switching Center), comprising the steps of:
a) storing system ID information of peripheral sub-PLMNs whose roaming services can be provided according to a geometric location and a convention, and transmitting a valid roaming list at a system information transmission, in an MSC;
b) comparing the received valid roaming list with a roaming list including system IDs of sub-PLMNs whose roaming services can be provided and roaming priorities according to the convention, in an MS (Mobile Station); and
c) scanning a peripheral sub-PLMN after a predetermined period of time if a sub-PLMN having a higher-order priority than a sub-PLMN currently providing a radio service exists in at least one sub-PLMN contained in the valid roaming list, and performing a roaming procedure for the sub-PLMN of the higher-order priority, in the MS.
